(19) United States
(12) Patent Application Publication
(10) Pub. No.: US 2024/0191552 A1
(43) Pub. Date: Jun. 13, 2024

(54) METHOD FOR ADJUSTING A VEHICLE DOOR, AND SYSTEM FOR ADJUSTING A VEHICLE DOOR

(71) Applicant: BROSE FAHRZEUGTEILE SE & CO. KOMMANDITGESELLSCHAFT, BAMBERG, Bamberg (DE)

(72) Inventors: Sabine MEHLER, Bamberg (DE); Florian WÖLKER, Hausen (DE); Daniel FÖRST, Bamberg (DE); Thomas STÖHR, Pfarrweisach (DE); Thomas SCHINDHELM, Neuhaus-Schierschnitz (DE); Stefan BICKEL, Bamberg (DE)

(21) Appl. No.: 18/554,186

(22) PCT Filed: Apr. 5, 2022
(86) PCT No.: PCT/EP2022/058936

§ 371 Date: Oct. 5, 2023

(30) Foreign Application Priority Data
Apr. 7, 2021 (DE) 10 2021 203 447.0

(51) Int. Cl. E05F 15/40; E05F 15/75

(52) U.S. Cl. CPC E05F 15/40; E05F 15/75; E05Y 2400/44; E05Y 2900/531

(57) ABSTRACT

It is provided a method for adjusting a vehicle door, at least having the following steps: using at least one presence sensor to test whether at least one body part of a vehicle door user is in a test area, and controlling a collision protection device of the vehicle door on the basis of whether a body part of the vehicle door user is in the test area, wherein the collision protection device is configured to monitor a monitoring area that differs from the test area and is in the area surrounding the vehicle door for possible obstacles using at least one monitoring sensor in order to avoid a collision between the vehicle door to be adjusted and an obstacle.

### BACKGROUND

The proposed solution relates to a method for adjusting a vehicle door, and to a system for adjusting a vehicle door.

Methods for adjusting a vehicle door are widely known. Sensor-assisted monitoring of a monitoring area in the area surrounding the vehicle door during an adjustment movement of the vehicle door, using a collision protection device, is also known.

By way of example, a collision protection device of this kind can be coupled to an adjustment mechanism of the vehicle door. In this case, in order to prevent a collision of the vehicle door with an obstacle, the collision protection device can be configured to stop and/or to reverse the adjustment of the vehicle door, if an obstacle is detected.

In principle, an adjustment movement of the vehicle door can be brought about in a manner actuated by muscle power and/or in a manner actuated by external force. Typically, in this case, muscle power is introduced via an outside door handle or an inside door handle. Thus, it may be necessary for a vehicle door user to move into the immediate vicinity of the vehicle door, in order to bring about the adjustment movement. In this case, the vehicle door user can periodically be at least in part in the monitoring area.

However, if the vehicle door user is at least in part in the monitoring area, said user may be identified, by the collision protection device, as an obstacle which precludes the adjustment of the vehicle door. Thus, the collision protection device may incorrectly stop an adjustment movement of the vehicle door.

### SUMMARY

There is therefore a need for improved methods and systems for adjusting vehicle doors.

In order to achieve this object, a method for adjustment of a vehicle door in a manner actuated by muscle power, as described herein, and a system as described herein, are proposed.

In this case, the proposed method comprises at least the following steps:
using at least one presence sensor to test whether at least one body part of a vehicle door user is in a test area, and
controlling a collision protection device of the vehicle door on the basis of whether a body part of the vehicle door user is in the test area, wherein the collision protection device is configured to monitor a monitoring area that differs from the test area and is in the area surrounding the vehicle door for possible obstacles using at least one monitoring sensor in order to avoid a collision between the vehicle door to be adjusted and an obstacle.

The test area that differs from the monitoring area makes it possible for the vehicle door user who is using the vehicle door to be distinguishable from a possible obstacle. In particular, the design of the test area makes it possible for the vehicle door user to be distinguishable from a person who is not using the vehicle door and consequently constitutes an obstacle for an adjustment movement of the vehicle door. It can thus be possible to prevent, by means of the proposed method, the vehicle door user being incorrectly identified as an obstacle, and the collision protection device incorrectly stopping the adjustment movement.

In this sense, use of the vehicle door by the vehicle door user means that the adjustment movement is brought about by the vehicle door user. In principle, in this case the adjustment movement can take place in a manner actuated by muscle power and/or in a manner actuated by external force.

The at least one presence sensor can, by way of example, be designed having a capacitive sensor, an inductive sensor, or an optical sensor. By way of example, in this case the at least one presence sensor can be arranged in the area of at least one operating element, in such a way that the presence of at least one body part of the vehicle user is identified, when operating the at least one operating element. In particular, the at least one presence sensor can identify the presence of a hand or an arm portion of a vehicle door user. In principle, however, the presence of any body part of the vehicle door user in the test area can be identified by means of the at least one presence sensor.

By way of example, the test area can extend immediately around the at least one operating element.

Alternatively or additionally, the at least one monitoring sensor of the collision protection device can be used as the presence sensor. By way of example, a monitoring sensor of this kind can be formed having a sensor array. On the basis of the information recorded by the sensor array, by way of example acquisition of a distance and/or outline of an object can take place. In particular, a classification of objects is conceivable and possible, by means of pattern recognition, on the basis of the information recorded by the sensor array. The sensor array can distinguish between a person in the test area and an obstacle, based on the classification and/or the distance.

By way of example, in the case of detection of at least one body part of the vehicle door user in the test area, the presence sensor can generate a presence signal and transmit this to a control unit. The control unit can be configured to transmit a control signal to the collision protection device, in response to receiving the presence signal from the presence sensor. On the basis of the control signal, the collision protection device can monitor the monitoring area using the at least one monitoring sensor.

By way of example, the collision protection device can be configured to monitor the monitoring area when the control signal shows that no body part of the vehicle door user is in the test area. Furthermore, the collision protection device can be configured to not monitor the monitoring area when the control signal shows that a body part of the vehicle door user is in the test area.

In principle, the collision protection device can be configured to stop and/or to reverse the adjustment movement of the vehicle door if it is identified that an adjustment of the vehicle could lead to a collision with an obstacle detected by means of the at least one monitoring sensor.

The collision protection device can comprise a further control unit. The further control unit can be coupled to the at least one monitoring sensor and to the adjustment mechanism of the vehicle door. In the event of a detection of an obstacle in the monitoring area, the at least one monitoring sensor can transmit a monitoring signal to the further control unit. The further control unit can be configured to stop and/or to reverse the adjustment movement of the vehicle door by means of the adjustment mechanism, upon receiving the monitoring signal.

By way of example, the test area can surround the at least one operating element of the vehicle door. For example, it is thus possible to identify, by means of the presence sensor, when the vehicle door user is approaching the at least one operating element of the vehicle door. As a result, the collision protection device can be controllable on the basis whether a body part of the vehicle door user is in the test area. This can prevent the vehicle door user, who is using the vehicle door, from being incorrectly identified as an obstacle, when said user brings about the adjustment movement of the vehicle door by means of the at least one operating element.

In one embodiment of the proposed solution, the testing can comprise a detection of whether the vehicle door user is touching at least one operating element on the vehicle door. Thus, the test area can also comprise an infinitesimal volume around the at least one operating element. As a result, an incorrect identification of a person in the vicinity of the at least one operating element, as the vehicle door user, can be avoidable.

By way of example, the detection of touching can be carried out by means of at least one touch sensor, in particular a capacitive or an inductive touch sensor. The at least one touch sensor can be connected to the control unit and can be configured to transmit a touch signal to the control unit in the event of touch being detected. The control unit can be configured, in the event of the touch signal being received, to transmit a control signal to the collision protection device. On the basis of the control signal, the collision protection device can monitor the monitoring area using the at least one monitoring sensor.

By way of example, the at least one operating element can be an outside door handle or an inside door handle. In principle, the at least one operating element can also be any form of a switch, which is configured to trigger an adjustment movement of the vehicle door upon actuation. In the case of a plurality of operating elements, the test area can be arranged around the plurality of operating elements. This can increase ease of operation.

According to the proposed solution, it is also possible to test whether the vehicle door user is touching the outside door handle or the inside door handle of the vehicle door. In principle, it can thus be possible to distinguish whether the adjustment movement is brought about via the outside door handle or the inside door handle. It can thus also be possible to distinguish whether the vehicle door user is inside or outside the vehicle.

In one embodiment of the proposed method, the collision protection device can be activated in response to the vehicle door user touching the inside door handle. In this case, the activated collision protection device can be configured to monitor the monitoring area using the at least one monitoring sensor.

By way of example, for activating the collision protection device, the control unit can be configured to transmit an activation signal to the collision protection device, in response to receiving the touch signal. In a further embodiment, the control unit can be configured to transmit the activation signal only when the touch signal shows that the vehicle door user is touching the inside door handle.

In one embodiment, the activation signal can be a component of the control signal. By way of example, the activation signal can correspond to a predetermined voltage or current level of the control signal.

In principle, the touch detection can make it possible to distinguish the cases where the vehicle door user opens the vehicle door while sitting in the vehicle, and where the vehicle door user opens the vehicle door while standing outside the vehicle.

If the vehicle door user opens the vehicle door while sitting in the vehicle, the corrosion protection device can be activated, in order to detect possible obstacles for the adjustment movement. If the vehicle door user opens the vehicle door while standing outside the vehicle, the collision protection device may not be activated, in order not to incorrectly identify the vehicle door user as an obstacle.

In principle, for motor-assisted adjustment of the vehicle door in a servo mode, the adjustment mechanism of the vehicle door can comprise a drive that is operated by external force. This can improve the ease of operation when adjusting the vehicle door.

The adjustment mechanism of the vehicle door can also be adjustable in a manner actuated by external force, without introducing additional muscle power. This can in particular make it possible for the vehicle door to be adjusted using a remote release means. In this case, the remote release means can be coupled to an identity recognition means. Thus, the adjustment of the vehicle door in a manner actuated by external force can take place in response to the recognition of a predetermined user identity. This can further increase the ease of operation of the vehicle door.

For triggering the proposed method, the testing can be able to be triggered by an operating event of the vehicle door user brought about by the vehicle door user. Thus, the collision protection device can monitor the monitoring area using the at least one monitoring sensor, on the basis of the testing, in each adjustment movement of the vehicle door. It can thus be possible to reduce a likelihood of collision of the vehicle door during the adjustment movement, in the case of opening and/or closing.

The detection of the operating event of the vehicle door can take place by means of at least one use sensor. By way of example, the at least one use sensor can be designed having an acceleration sensor. By way of example again, the at least one use sensor can also comprise a piezoelectric sensor for detecting the introduced adjustment force.

The at least one use sensor can be connected to the control unit and can be configured to transmit a use signal to the control unit in the event of the operating event of the vehicle door being detected. The control unit can be configured, in the event of the use signal being received, to transmit a control signal, in particular an activation signal, to the collision protection device.

The collision protection device can be activatable in response to receiving the activation signal.

In principle, the collision protection device can be configured to remain activated, in the event of receiving the activation signal in an activated state.

The control unit can be configured to activate the at least one drive of the adjustment mechanism, in response to receiving the use signal. Thus, the motorized adjustment force for adjustment of the vehicle door in a manner actuated by external force or assisted by motor can be able to be introduced into the vehicle door via the use event.

In one embodiment, the at least one use sensor can also be used as the at least one touch sensor. Thus, the control unit can be configured to receive the use signal from the at least one touch sensor.

The test area can be able to be determined on the basis of an expected and/or actual adjustment movement of the vehicle door. This can further reduce the likelihood of a collision of the vehicle door with an obstacle.

In particular, the test area can be able to be determined on the basis of an expected and/or actual adjustment direction of the vehicle door. Thus, the test area for an actual and/or expected opening process of the vehicle door along a first adjustment direction can differ from the test area for an actual and/or expected closing process of the vehicle door along a second adjustment direction. By way of example, the test area for the actual and/or expected opening process can be located on the outside of the vehicle door, e.g. in the region of the outside door handle. By way of example again, the test area for the actual and/or expected closing process can be located on the inside of the vehicle door, e.g. in the region of the inside door handle. By way of example, the collision protection device can be activated, in the case of the actual and/or expected opening process of the closed vehicle door, via the inside door handle, but not via the outside door handle. Likewise by way of example, the collision protection device can be activated, in the case of the actual and/or expected closing process of the open vehicle door, via the outside door handle, but not via the inside door handle.

The different arrangement of the test area can be achieved by means of a plurality of presence sensors. In this case, the above statements regarding the at least one presence sensor apply for each of the plurality of presence sensors. For an adaptation of the test area on the basis the expected and/or actual adjustment movement, the control unit can be configured to ignore presence signals from a selection of the plurality of the presence sensors. In this case, the selection can depend on the expected or the actual adjustment direction of the vehicle door.

By way of example, in the case of an expected or actual opening process, the control unit can transmit the activation signal to the collision protection device, in response to the presence signal of a presence sensor on the inside door handle, while the presence signal of a presence sensor on the outside door handle is ignored. By way of example again, in the case of an expected or actual closing process, the control unit can transmit the activation signal to the collision protection device, in response to the presence signal of the presence sensor on the outside door handle, while the presence signal of the presence sensor on the inside door handle is ignored. Alternatively, the control unit can be configured to deactivate individual presence sensors of the plurality of presence sensors, based on the expected and/or actual adjustment movement.

The actual adjustment movement can be able to be determined from an adjustment position and/or an adjustment speed of the vehicle door. This can improve the prediction of the expected or actual adjustment movement.

The adjustment position of the vehicle door can be achieved by means of at least one position sensor. By way of example, a position sensor of this kind can be designed having at least one acceleration sensor. Alternative or additionally, the position sensor can be designed having a coupling to the adjustment mechanism. In particular, the position sensor can be configured to assign the vehicle door an adjustment position on an adjustment path, between a closed and a fully open position. By way of example, such an assignment can take place, in the case of a pivotable vehicle door, via an opening angle. By way of example, an opening angle of this kind can be enclosed between a longitudinal extension axis of the vehicle and a longitudinal extension axis of the vehicle door. By way of example, an opening angle of 0° can thus correspond to a closed door.

The at least one position sensor can be coupled to the control unit and can be configured to transmit data regarding the adjustment position of the vehicle door to the control unit.

The adjustment speed can be defined as a temporal derivative of the adjustment position. Thus, a sign of the adjustment speed can contain information relating to an adjustment direction. In particular, a direction reversal of the adjustment movement can be concluded from a reversal of the sign of the adjustment speed. Furthermore, a zero-crossing of the adjustment speed can suggest an interruption and/or a direction reversal of the adjustment movement.

The expected adjustment movement can be able to be determined using logics, from the above-described adjustment position and/or the adjustment speed of the vehicle door.

Logics of this kind can, by way of example, assign a closed vehicle door the adjustment movement along the first adjustment direction, as the expected movement. Furthermore, logics of this kind can assign a fully closed vehicle door the adjustment movement along the second adjustment direction, as the expected movement. By way of example again, the interruption and/or the direction reversal of the adjustment movement can be predictable on the basis of a time profile of the adjustment position and/or of the adjustment speed. In order to predict the expected adjustment movement, the logics can be trainable and/or individualizable by means of the identity recognition. In principle, the control unit can be configured to apply the logics, for determining the expected adjustment movement, to the determined adjustment position and/or adjustment speed.

In a further embodiment, the activated collision protection device can be deactivated if it is identified, by means of the at least one presence sensor, that a body part of the vehicle door user is in the test area, or the deactivated collision protection device can be activated if it is identified, by means of the at least one presence sensor, that there is no body part of the vehicle door user in the test area.

The deactivated collision protection device can be configured to not monitor the monitoring area.

In order to deactivate the collision protection device, the control unit can be configured, by way of example, to transmit a deactivation signal to the collision protection device, in response to receiving the presence signal from the presence sensor. The collision protection device can be deactivatable in response to receiving the deactivation signal.

In one embodiment, the collision protection device can be activatable and deactivatable by the further control means of the collision protection device. In this case, the further control means of the collision protection device can be configured to stop and/or to reverse the adjustment movement of the vehicle door, upon receiving the monitoring signal, only in an activated state. The further control means can be deactivatable in response to receiving the deactivation signal, and activatable in response to receiving the activation signal.

In the deactivated state, the further control unit can, in contrast, be configured not to trigger any subsequent processes, in response to receiving the deactivation signal. Thus, a collision protection device that is already deactivated can remain deactivated, upon receiving a further deactivation signal.

In one embodiment, the deactivation signal can be a component of the control signal. By way of example, the deactivation signal can correspond to a predetermined voltage or current level of the control signal.

By way of example, for deactivating the collision protection device in response to a touch detection, the control unit can be configured to transmit a deactivation signal to the collision protection device, in particular to the further control unit, in response to receiving the touch signal. In a further embodiment, the control unit can be configured to transmit the deactivation signal only when the touch signal shows that the vehicle door user is touching the outside door handle.

In the case of an activated collision protection device, the testing can be repeated at predetermined time intervals.

It can thus be possible to test, in regular intervals, whether at least one body part of the vehicle door user is in the test area. In particular, it is possible to regularly test, in the course of the adjustment movement, whether the vehicle door user has entered the test area. It can thus be possible to prevent vehicle door users moving around the vehicle door, during the adjustment movement, from being incorrectly identified as an obstacle.

By way of example, the adjustment movement can take place in multi-phase manner, wherein the collision protection device can be activated in at least one of the phases and can be deactivated in at least one of the phases. By way of example, the collision protection device can be activated in the event of opening the vehicle door via the inside door handle. In this case, the first phase of the adjustment movement takes place when the collision protection device is activated. In the course of the adjustment movement, the vehicle door user can leave the vehicle interior and move around the vehicle door, in order to open the vehicle door further, via the outside door handle, in the second phase. It can be possible to detect, by the repeated testing, that the vehicle door user has entered the test area, at least in part. Thereupon, the collision protection device can be deactivated. The incorrect identification of the vehicle door user as an obstacle can thus be avoidable.

For testing in predetermined time intervals, the at least one presence sensor can be configured to receive a test command. In response to receiving the test command, the at least one presence sensor can carry out the test.

In one embodiment, the at least one presence sensor can be coupled to a timer. The timer can be configured to transmit the test command to the at least one presence sensor in the predetermined time intervals.

In a further embodiment, the timer can transmit information relating to a system time, to the at least one presence sensor, continuously or quasi-continuously. In this case, quasi-continuously relates to a sequence of temporally discrete transmission processes, which are suitable for determining expiry of the predetermined time intervals with negligible error. By way of example, the timer has a transmission frequency which corresponds at most to ⅕ of the predetermined time intervals, in particular at most 1/10 of the predetermined time intervals. The at least one presence sensor can determine expiry of the predetermined intervals based on the system time received via the timer, and perform a test after each expiry.

In a further embodiment, the timer can be coupled to the control unit. The timer can be configured to transmit a time signal to the control unit at the predetermined time intervals. The control unit can transmit the test command to the at least one presence sensor, in response to receiving the time signal. Alternatively, the timer can transmit information relating to a system time, to the control unit, continuously or quasi-continuously. The control unit can determine expiry of the predetermined intervals based on the system time received via the timer, and transmit the test command to the at least one presence sensor after each expiry.

In one embodiment of the repeated testing, testing can be carried out quasi-continuously after predetermined time intervals. In this case, quasi-continuously refers to temporally discrete testing processes of a frequency, which are suitable for detecting every change to the situation to be tested, to be expected in normal use, more quickly than the usual reaction time of a person. By way of example, the quasi-continuous testing has a frequency of above 5 Hz, in particular above 10 Hz.

The testing can be repeated if the adjustment position of the vehicle door reaches a predetermined test position. As a result, alternatively or in addition to repeating the testing after predetermined time intervals, the multi-phase adjustment movement can be achievable.

The control unit can be configured to receive the data, regarding the adjustment position, from the at least one position sensor, to compare these with the predetermined test position, and, in response to the adjustment position reaching the predetermined test position, to transmit the deactivation signal to the collision protection device.

Alternatively, the position sensor can also compare the identified adjustment position with the predetermined test position, and, in response to the adjustment position reaching the predetermined test position, can transmit a position signal to the control unit. The control unit can be configured to transmit the test command to the at least one presence sensor, upon receiving the position signal.

In principle, the test position can be defined by a plurality of predetermined adjustment positions. In the case of the vehicle door being designed as a pivotable vehicle door, the test position can correspond to a plurality of not necessarily cohesive regions of the opening angle. Alternatively, the test position can also correspond to a cohesive region of the opening angle. In particular, the test position can be formulatable using at least one “greater than or equal to” or “smaller than or equal to” logical condition.

In one embodiment, the activated collision protection device can be deactivated if the repeated testing reveals that at least one body part of the vehicle door user is in the test area. The ease of operation can be further improved as a result.

In addition, every type of the repeated testing can be ended if the adjustment position has reached a predetermined final position, and/or a time period since the most recent operating event has reached a predetermined maximum time. As a result, a consumption of electrical power can be able to be reduced, in particular in the case of a closed vehicle door and/or permanently open vehicle door.

The collision protection device can be activated if an adjustment position of the vehicle door reaches a predetermined activation position.

In particular, the collision protection device can be activated again in the course of an adjustment movement. By way of example, the adjustment movement can take place in multi-phase manner, wherein the collision protection device can be activated in at least one of the phases and can be not activated or deactivated in at least one of the phases. By way of example, the vehicle door user can bring about the adjustment movement, wherein the collision protection device is not activated by the presence of at least one body part of the vehicle door user in the test area. In this case, the first phase of the adjustment movement can take place when the collision protection device is not activated. In the course of the adjustment movement, the vehicle door user may leave the test area. If the adjustment position of the vehicle door reaches the activation position after the test area has been left, the collision protection device can be activated. If the vehicle door is adjusted further out of the activation position in the second phase of the adjustment movement, said second phase can take place when the collision protection device is activated. It is thus possible, for example, for the closed vehicle door to be opened by a vehicle door user standing outside the vehicle, without the vehicle door user being incorrectly identified as an obstacle. In the course of the adjustment movement, the vehicle door user can move out of the test area in order, for example in the case of a pivotable vehicle door, to move between the vehicle door and an access point released by the vehicle door. The further adjustment of the vehicle door can take place only when the collision protection device is activated. This can reduce a risk of collision of the vehicle door with obstacles, in particular in processes of getting in and getting out.

The adjustment position of the vehicle door can, as described above, be achieved by means of at least one position sensor.

The at least one position sensor can be coupled to the control unit and can be configured to transmit data regarding the adjustment position of the vehicle door to the control unit. The control unit can be configured to receive the data regarding the adjustment position, to compare these with the predetermined activation position, and, in response to the adjustment position having reached the predetermined activation position, to transmit the activation signal to the collision protection device.

Alternatively, the position sensor can also compare the identified adjustment position with the predetermined activation position, and, in response to the adjustment position having reached the predetermined activation position, can transmit a position signal to the control unit. The control unit can thus also be configured, in the event of the position signal being received, to transmit the activation signal to the collision protection device.

In principle, the predetermined activation position can be defined by a plurality of predetermined adjustment positions at which the collision protection device can be activated.

The activation position can be defined by means of a not necessarily cohesive region of the opening angle. In particular, the activation position can be formulatable using a “greater than or equal to” or “smaller than or equal to” logical condition.

The collision protection device can also be activatable on the basis of the adjustment speed of the vehicle door.

In principle, the zero-crossing of the adjustment speed can be linked to an interruption of the adjustment movement. Interruptions and or a direction reversal of the adjustment movement can in practice be associated with a vehicle door user moving around the vehicle door. Therefore, the collision protection device can be activatable by the activation on the basis of the adjustment speed after interruptions and/or the direction reversal of the adjustment movement. This can further improve the collision protection for a vehicle door.

The adjustment speed can be achieved via the above-described at least one position sensor. In the event of the at least one position sensor transmitting the data, regarding the adjustment position, to the control unit, the control unit can be configured to determine the adjustment speed by derivation of the adjustment position according to time. In the event of a zero-crossing and/or a direction reversal, the control unit can transmit the activation signal to the collision protection device. Alternatively, the position sensor can determine the adjustment speed and, in the event of a zero-crossing and/or a direction reversal, transmit a position signal to the control unit. In the event of the position signal being received, the control unit can transmit the activation signal to the collision protection device. In principle, the determination of the adjustment speed can also take place using at least one speed sensor. In this case, the statements regarding possible embodiments for activating the collision protection device with the aid of the adjustment speed determined by means of the at least one position sensor apply analogously for the adjustment speeds determined by means of the at least one speed sensor.

In one embodiment, the collision protection device can be activated if it is identified, by sensors, that the vehicle door is adjusted by a vehicle door user at an adjustment speed that exceeds a predefined speed threshold value. A speed threshold value of this kind can, by way of example, include only the amount, or the amount and the sign, of the adjustment speed. By way of example, the collision protection device can thus be activated by each adjustment movement having an adjustment speed that exceeds the speed threshold value, irrespective of the adjustment direction. Alternatively, the collision protection device can be activated by each adjustment movement having an adjustment speed that exceeds the speed threshold value, along exactly one adjustment direction. By way of example, the collision protection device can be activated by each adjustment of the vehicle door along the second adjustment direction.

A result of the testing for presence and/or a detection of an obstacle can be displayed via an optical and/or acoustic signal. This can improve the perception of a testing or detection result.

By way of example, the vehicle door user can be informed that the collision protection device is deactivated on account of the presence of at least one body part of the vehicle door user in the test area. Furthermore, the vehicle door user can be informed that, on account of the detection of an obstacle, the adjustment movement may lead to a collision of the vehicle door with an obstacle. In principle, the optical and/or acoustic signal can be output in addition to or alternatively to stopping or reversing the adjustment movement by mean of the adjustment mechanism.

The signal can be output by means of at least one acoustic and/or optical signal generator of the collision protection device, in a manner perceptible for a vehicle door user and/or further persons. The collision protection device can be configured to output a signal via the at least one signal generator, in response to receiving a deactivation signal. Furthermore, the collision protection device can be configured to output a signal via the at least one signal generator, in response to the detection of an obstacle. In order to distinguish the situations shown, a first signal generator can be configured to display the deactivation of the collision protection device, and a second signal generator can be configured to display the detection of an obstacle.

Alternatively or in addition, the vehicle door user and/or further persons can be shown, via a signal generator, that the collision protection device is activated.

In principle, the monitoring by the collision protection device of the monitoring area, during the activated state, can take place continuously or in a temporally discrete manner. By way of example, the at least one monitoring sensor can be configured, in this case, to determine a distance between the at least one monitoring sensor and an obstacle within the monitoring area.

In one embodiment of the proposed solution, the at least one monitoring sensor can comprise at least one radar sensor. In principle, the at least one monitoring sensor can be formed having any type of sensor that is configured for measuring a distance to an object.

When spatially resolving monitoring sensors are used, the at least one monitoring sensor can, in this case, detect a plurality of distances. By way of example, the essential distance of the plurality of detected distances can be the minimum distance detected within a specified temporal integration interval. The at least one monitoring sensor can be configured to compare the detected distance or the essential distance from the plurality of detected distances with a predetermined threshold value. In the event of the distance or the essential distance falling below the threshold value, the at least one monitoring sensor can be configured to transmit a monitoring signal to the further control unit of the collision protection device. The collision protection device can stop and/or reverse the adjustment movement of the vehicle door, in response to receiving the monitoring signal. Alternatively, the at least one monitoring sensor can transmit, to the control unit, data relating to the determined distance or the essential distance. The control unit can be configured to compare the distance or the essential distance with the predetermined threshold value and, in response to the distance or the essential distance falling below the predetermined threshold value, to stop and/or reverse the adjustment movement.

In principle, the collision protection device can be configured to determine a distance between a possible obstacle and the vehicle door. By way of example, this determination can take place on the basis of the distance, determined by the at least one monitoring sensor, between the at least one monitoring sensor and the possible obstacle, as well as the adjustment position of the vehicle door.

In one embodiment, the collision protection device can be configured to stop and/or to reverse the adjustment movement if the distance between the vehicle door and the possible obstacle falls below a predetermined threshold value. By way of example, the threshold value can depend on the adjustment speed.

By way of example, the monitoring area, determined by measurement technology, by means of the at least one monitoring sensor, can correspond at least to the adjustment area of the vehicle door travelled over by the vehicle door during the adjustment between the closed position and the maximally open position.

By way of example, the monitoring area can be larger than the adjustment area of the vehicle door. This can allow for an early prediction of entry of moving obstacles entering the pivot area.

In principle, the stopping of the adjustment movement by the collision protection device can comprise braking of an adjustment movement until the vehicle door is at a standstill. Furthermore, the stopping can comprise blocking the adjustability of the vehicle door against new adjustment.

In an additional embodiment, the blocking of the vehicle door against new adjustment can be limited to exactly one of the possible adjustment directions. By way of example, on account of the detection of an obstacle in the direction of the first adjustment direction, the vehicle door can thus be adjustable along the second adjustment direction, but blocked for an adjustment along the first adjustment direction.

The object mentioned at the outset is furthermore also achieved by means of a system as described herein. In this case, the proposed system comprises:
a collision protection device (2) comprising at least one monitoring sensor (21A, 21B), wherein the collision protection device (2) is configured to monitor a monitoring area (22) in the area surrounding the vehicle door (11) for possible obstacles (O) using at least one monitoring sensor (21A, 21B) in order to avoid a collision between the vehicle door (11) to be adjusted and an obstacle (O),
at least one presence sensor (23A, 23B), and
a control unit (3) which is coupled to the at least one presence sensor (23A, 23B) and the collision protection device (2) and which is configured to test, by means of the at least one presence sensor (23A, 23B), whether at least one body part of a vehicle door user (U) is in a test area (24) that is different from the monitoring area (22), and to control the collision protection device (2) on the basis of whether a least one body part of the vehicle door user (U) is in the test area (24).

Thus, the system according to the proposed solution can monitor the monitoring area when the testing reveals that no body part of the vehicle door user is in the test area. Furthermore, the system can be configured to not monitor the monitoring area when the testing reveals that a body part of the vehicle door user is in the test area. It can thus be possible to prevent, by means of the proposed system, the vehicle door user being incorrectly identified as an obstacle, and the collision protection device incorrectly stopping the adjustment movement.

Furthermore, additionally or alternatively, for motor-assisted pivoting of the vehicle door the proposed system can comprise at least one drive that is coupled to the adjustment mechanism of the vehicle door.

The system can comprise the at least one touch sensor for touch detection at the at least one operating element of the vehicle door. The at least one touch sensor can be coupled to the control unit. As stated above with reference to the method, the at least one touch sensor can be used for testing whether at least one body part of the vehicle door user is in the test area.

In a further embodiment of the proposed system, the system can comprise the at least one use sensor for detecting the operating event of the vehicle door. As stated above with reference to the proposed method, the at least one use sensor can, by way of example, be designed having an acceleration sensor or touch sensor, such as a capacitive sensor. By way of example again, the at least one use sensor can also comprise a piezoelectric sensor for detecting the introduced adjustment force.

In principle, the at least one touch sensor can also be used as the at least one use sensor. For further embodiments relating to the use sensor and the touch sensor, reference is made to the above statements within the context of the proposed method.

For identifying the adjustment position of the vehicle door, the system can comprise at least the position sensor that is coupled to the control means. The control unit can be configured to activate the collision protection device, by an adjustment of the vehicle door, when the adjustment position reaches a predetermined activation position.

The above explanations regarding embodiments and advantages of the proposed method also apply analogously to the proposed system.

Furthermore, the problem set out at the outset is also solved by a vehicle comprising a vehicle door and the proposed system for adjusting the vehicle door.

### BRIEF DESCRIPTION OF THE DRAWINGS

The accompanying drawings illustrate, by way of example, possible variants of the proposed solution.

In this case, the above explanations regarding embodiments and advantages of the proposed system also apply analogously to the proposed vehicle.

In the drawings:

FIG. 1 shows a block diagram of an embodiment of a system according to the proposed solution, comprising a use sensor, a presence sensor, a control unit, and a collision protection device.

FIG. 2 shows a perspective view of a detail of a proposed vehicle, comprising a pivotable vehicle door, and an embodiment of the proposed system.

FIGS. 3A to 3C show plan views of an embodiment of the proposed vehicle in different use situations.

FIGS. 4A to 5B show plan views of a further embodiment of the proposed vehicle in different use situations.

FIG. 6 shows a plan view of a further embodiment of the proposed vehicle comprising a sliding door.

FIG. 7 shows a flow diagram of a variant of the proposed method and

FIG. 8 shows a flow diagram of a further variant of the proposed method.

### DETAILED DESCRIPTION

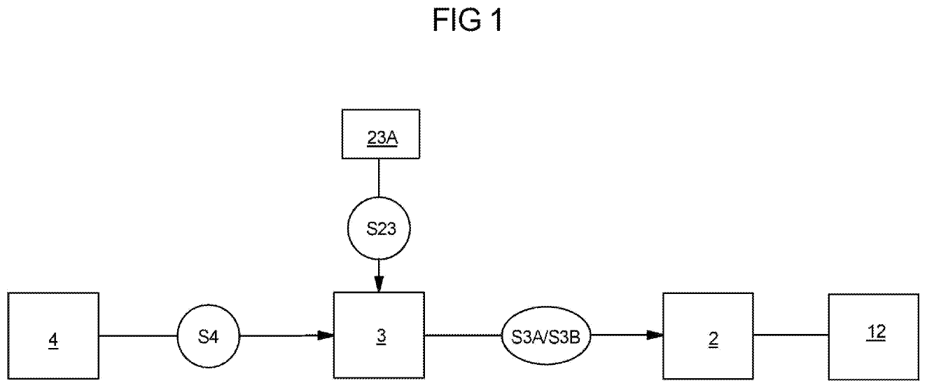

FIG. 1 shows a first variant of a proposed system for adjusting a vehicle door 11. A system of this kind comprises at least one collision protection device 2 comprising at least one monitoring sensor 21A, 21B. In this case, the collision protection device 2 is configured to monitor a monitoring area 22 in the area surrounding the vehicle door 11 for possible obstacles O using at least one monitoring sensor 21A, 21B in order to avoid a collision between the vehicle door 11 to be adjusted and an obstacle O. The system further comprises at least one presence sensor 23A, 23B, and a control unit 3 that is coupled to the at least one presence sensor 23A, 23B and to the collision protection device 2. The control unit 3 is configured to test, by means of the at least one presence sensor 23A, 23B, whether at least one body part of a vehicle door user U is in a test area 24 that is different from the monitoring area 22, and to control the collision protection device 2 on the basis of whether a least one body part of the vehicle door user U is in the test area 24.

In the embodiment shown in FIG. 1, the presence sensor 23A is configured to transmit a presence signal S23 to the control unit 3 if at least one body part of the vehicle door user U is in the test area 24. The control unit 3 is configured to receive the presence signal S23 and, in response to receiving the presence signal S23, to deactivate the collision protection device 2 by means of a deactivation signal S3A. Thus, the control unit 3 is configured to deactivate the collision protection device 2 if at least one part of the vehicle door user U is in the test area 24. Furthermore, the system comprises a use sensor 4 for identifying an operating event of the vehicle door 11. The use sensor 4 is coupled to the control unit 3 and is configured to transmit the use signal S4 to the control unit 3, in response to a detection of the operating event. The control unit 3 is in turn configured to transmit an activation signal S3B to the collision protection device 2, in response to receiving the use signal S4.

In an embodiment by way of example, the at least one presence sensor S23A can be designed having a capacitive sensor, an inductive sensor, or an optical sensor.

In a further embodiment, the at least one monitoring sensor 21A of the collision protection device 2 can be used as the presence sensor 32A. By way of example, a monitoring sensor 21A, 23A of this kind can be formed having a sensor array. On the basis of the information recorded by the sensor array, by way of example acquisition of a distance and/or outline of an object can take place. In particular, a classification of objects is conceivable and possible, by means of pattern recognition, on the basis of the information recorded by the sensor array. The sensor array can distinguish between a person in the test area 24 and an obstacle O, based on the classification and/or the distance.

In a further alternative embodiment, the collision protection device 2 can comprise a further control unit. The further control unit can be coupled to the at least one monitoring sensor 21A and to the adjustment mechanism 12 of the vehicle door 11. In the event of a detection of an obstacle in the monitoring area 22, the at least one monitoring sensor 21A can transmit a monitoring signal S21 to the further control unit. The further control unit can be configured to stop and/or to reverse the adjustment movement of the vehicle door 11 by means of the adjustment mechanism 12, upon receiving the monitoring signal S21, when in an activated state. In a deactivated state, the further control unit can, in contrast, be configured not to trigger any subsequent processes, in response to receiving the deactivation signal S3A. Thus, a collision protection device 2 that is already deactivated can remain deactivated, upon receiving a further deactivation signal S3A.

In a further embodiment, for detection of touching the proposed system can comprise at least one touch sensor, in particular a capacitive or an inductive touch sensor. The at least one touch sensor can be connected to the control unit 3 and can be configured to transmit a touch signal to the control unit 3 in the event of touch being detected. The control unit 3 can be configured, in the event of the touch signal being received, to transmit a deactivation signal S3A to the collision protection device 2. The collision protection device 2 can in turn be deactivatable in response to receiving the deactivation signal S3A.

In one embodiment, the at least one use sensor 4 can also be used as the at least one touch sensor. Thus, the control unit 3 can be configured to receive the use signal S4 from the at least one touch sensor.

For motor-assisted adjustment of the vehicle door 11, the adjustment mechanism 12 of the vehicle door can comprise a drive that is operated by external force.

In a further alternative embodiment, the proposed system can comprise a plurality of presence sensors 23A, for adapting the test area 24. In this case, the control unit 3 can be configured to ignore presence signals S32 from a selection of the plurality of the presence sensors 23A. In this case, the selection can depend on the expected or the actual adjustment direction of the vehicle door 11. Alternatively, the control unit 3 can be configured to deactivate individual presence sensors 23A of the plurality of presence sensors 23A.

For determining an adjustment position of the vehicle door 11, the proposed system can comprise at least one position sensor. By way of example, a position sensor of this kind can be designed having at least one acceleration sensor. Alternative or additionally, the position sensor can be designed having a coupling to the adjustment mechanism 12. The at least one position sensor can be coupled to the control unit 3 and can be configured to transmit data regarding the adjustment position of the vehicle door 11 to the control unit 3.

For testing in predetermined time intervals, the at least one presence sensor 23A can be configured to receive a test command. In response to receiving the test command, the at least one presence sensor 23A can carry out the test.

In one embodiment, the at least one presence sensor 23A can be coupled to a timer. The timer can be configured to transmit the test command to the at least one presence sensor 23A in the predetermined time intervals. In a further embodiment, the timer can be coupled to the control unit 3. The timer can be configured to transmit a time signal to the control unit 3 at the predetermined time intervals. The control unit 3 can transmit the test command to the at least one presence sensor 23A, in response to receiving the time signal.

In a further embodiment of the proposed system, for displaying a result of the testing for presence and/or the detection of an obstacle, the system can comprise an acoustic and/or an optical signal generator. The collision protection device 2 can be configured to output a signal via the at least one signal generator, in response to receiving a deactivation signal S3A. Furthermore, the collision protection device 2 can be configured to output a signal via the at least one signal generator, in response to the detection of an obstacle. In order to distinguish the situations shown, a first signal generator can be configured to display the deactivation of the collision protection device 2, and a second signal generator can be configured to display the detection of an obstacle.

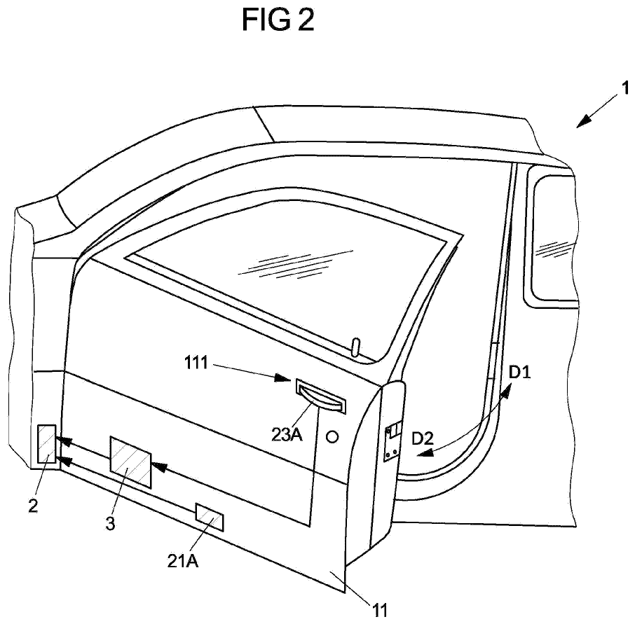

FIG. 2 is a detail of a vehicle 1 according to the proposed solution. The vehicle 1 comprises a vehicle door 11 that is half-opened and is hinged to a body of the vehicle 1 so as to be pivotable along the first adjustment device D1 and the second adjustment device D2. Furthermore, the vehicle 1 comprises the system according to the proposed solution, comprising a collision protection device 2, a control unit 3, a presence sensor 23A, and a monitoring sensor 21A. In this case, the presence sensor 23A is formed as a touch sensor on the outside door handle 111. Furthermore, the presence sensor 23A is connected to the control unit 3 in order to transmit the presence signal S23 to the control unit 3, in response to the detection of touching of the outside door handle 111. The control unit 3 is coupled to the collision protection device 2 in order, in response to receiving the presence signal S23, to transmit the deactivation signal S3A to the collision protection device 2. The monitoring sensor 21A is coupled to the collision protection device 2 and is configured, in the event of the detection of an obstacle, to transmit the monitoring signal S21 to the collision protection device 2.

In alternative embodiments of the proposed vehicle 1, this can in principle comprise a plurality of monitoring sensors 21A and a plurality of presence sensors 23A. In this case, individual presence sensors 23A and/or monitoring sensors 21A can also be arranged on the inside of the vehicle door 11 and/or the body of the vehicle 1.

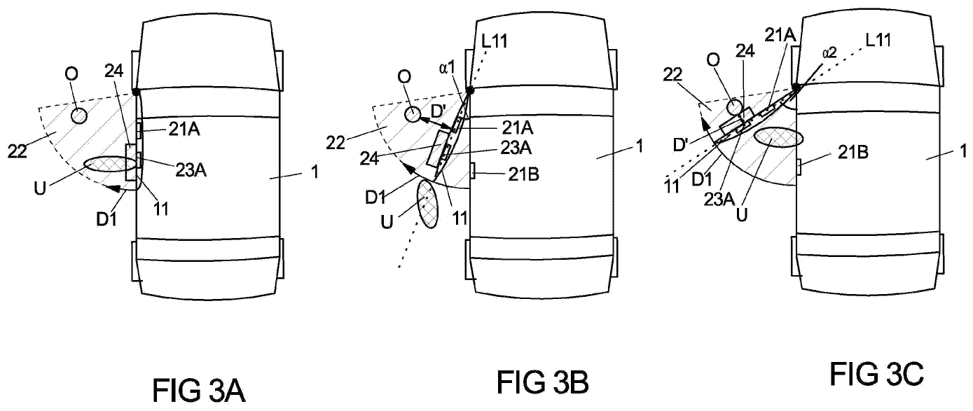

FIGS. 3A to 3C in each case show an embodiment of the proposed vehicle 1 comprising a pivotable vehicle door 11, a further embodiment of the proposed system, and an obstacle O and a vehicle door user U in different positions relative to the vehicle 1. In this case, the different positions of the vehicle door user U represent a typical process of getting into the vehicle 1. In contrast to the vehicle 1 shown in FIG. 2, the system shown in FIGS. 3A to 3C in each case comprises the presence sensor 23A in an embodiment which is configured to identify the presence of at least a portion of the vehicle door user U in the test area 24. In this case, the presence sensor 23A is arranged in the area of the outside door handle 111, in such a way that the outside door handle 111 is located inside the test area 24. Furthermore, in addition to the monitoring sensor 21A, the system comprises the monitoring sensor 21B arranged on the body. In contrast, the monitoring sensor 21A is in this case arranged on an outside of the vehicle door 11. The monitoring sensor 21B is arranged in the foot area of an access point that can be released by the vehicle door 11. The collision protection device 2 is configured to monitor the monitoring area 22 by means of the monitoring sensors 21A, 21B. In this case, the monitoring area 22 substantially corresponds to the pivot area of the vehicle door 11.

In FIG. 3A, the vehicle door 11 is in a closed state. The opening angle of the vehicle door 11 thus corresponds to 0°. A vehicle door user U is outside the vehicle 1, immediately in front of the vehicle door 11, in order to introduce an adjustment force, directed along the first adjustment device D1, into the vehicle door 11, via the outside door handle 111. In this case, the vehicle door user U is at least in part in the test area 24. Consequently, the collision protection device 2 is deactivated, in order to prevent the vehicle door user U being incorrectly identified as a possible obstacle. Furthermore, the obstacle O, which could collide with the vehicle door 11 in the event of an adjustment of the vehicle door 11, is in the monitoring area 22.

FIG. 3B shows, in contrast to FIG. 3A, the partially opened vehicle door 11 having an opening angle α1 of greater than or equal to 0. Compared with FIG. 3A, the vehicle door user U in FIG. 3B has moved out of the monitoring area 22 and the test area 24. The vehicle door user U is in a position that is offset, relative to the vehicle door 11, along the longitudinal extension axis L11 of the vehicle door 11. This corresponds to a typical position which the vehicle door user U assumes in the context of a process of getting into the vehicle 1. In this case, the opening angle α1 is greater than or equal to an opening angle which defines the activation position. The collision protection device 2 is thus activated. Consequently, the obstacle O can be detected by means of the monitoring sensors 21A, 21B. On the basis of the distance D′, determined by the collision protection device 2, between the obstacle O and the vehicle door 11, the adjustment movement of the vehicle door 11 along the first adjustment device D1 can be stopped and/or reversed.

In contrast to FIG. 3B, FIG. 3C show the further opened vehicle door 11, having the opening angle α2>α1. The vehicle door 11 fully releases access to an interior of the vehicle 1. Compared with FIG. 3B, in this case the vehicle door user U in FIG. 3C has moved into the monitoring area 22 between the vehicle door 11 and the vehicle 1. The vehicle door user U is thus not within the test area 24. Consequently, the collision protection device 2 is activated. Thus, both the vehicle door user U and the obstacle O can be detectable as possible obstacles O for the adjustment movement. Based on the adjustment movement along the adjustment direction D1, in this case only the obstacle O is determined as a possible obstacle O, by the collision protection device 2. On the basis of the distance D″, determined by the collision protection device 2, between the vehicle door 11 and the obstacle O, the collision protection device 2 can stop and/or reverse the adjustment movement along the adjustment device D1.

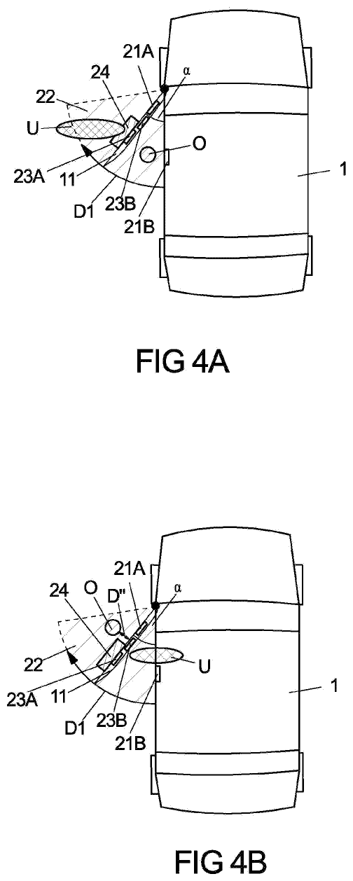

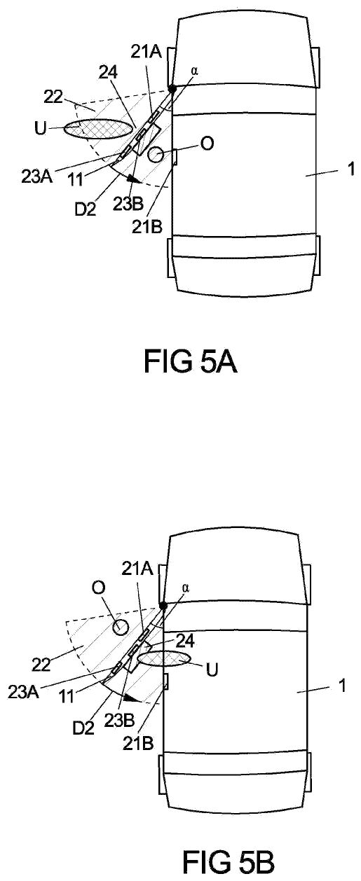

FIGS. 4A to 5B show the proposed vehicle comprising a pivotable vehicle door 11, and a further embodiment of the proposed system. In contrast to the embodiment shown in FIGS. 3A to 3C, the system comprises a further presence sensor 23B, in addition to the presence sensor 23A. In this case, the presence sensor 23A is arranged analogously to the presence sensor 23A in the embodiment shown in FIGS. 3A to 3C. The further presence sensor 23B is arranged in the area of the inside door handle of the vehicle door 11. The test area 24 is arranged around the outside door handle 111, on the basis of the adjustment device D1.

In FIG. 4A a vehicle door user U, viewed from the vehicle 1, is beyond the half-open vehicle door 11. In this case, at least one part of the vehicle door user U is in the test area 24, which is arranged around the outside door handle 111. Furthermore, the vehicle door user U is at least in part in the monitoring area 22. The vehicle door user U introduces an adjustment force, acting along the first adjustment direction D1, into the vehicle door 11, via the outside door handle 111. The collision protection device 2 is thus deactivated. Consequently, the adjustment movement along the first adjustment direction D1 is neither stopped nor reversed. The obstacle O located between the vehicle door 11 and the vehicle 1 likewise cannot trigger stopping and/or reversal of the adjustment movement along the first adjustment direction D1, on account of the deactivated collision protection device 2.

Compared with FIG. 4A, FIG. 4B the vehicle door user U is arranged in part between the vehicle door 11 and the vehicle 1, and in part in the vehicle 1. In contrast to FIG. 4A, the obstacle O, viewed from the vehicle 1, is located beyond the vehicle door 11, within the monitoring area 22. Via the inside door handle, the vehicle door user U introduces an adjustment force, acting along the first adjustment device D1, into the vehicle door 11. The opening angle α is greater than or equal to the opening angle defining the activation position. Thus, in FIG. 4B the collision protection device 2 is activated again, compared with FIG. 4A. On the basis of the distance D″, the collision protection device 2 can stop and/or reverse the adjustment movement along the adjustment direction D1.

FIGS. 5A and 5B show the vehicle 1 of the embodiment shown in FIGS. 4A and 4B. The test area 24 is arranged around the inside door handle, on the basis of the second adjustment device D2.

In FIG. 5A, analogously to FIG. 4A the vehicle door user U, viewed from the vehicle 1, is beyond the vehicle door 11. Via the outside door handle 111, the vehicle door user U introduces an adjustment force, acting along the second adjustment direction D2, into the vehicle door 11. In this case, the vehicle door user U is not in the test area 24. The collision protection device 2 is accordingly activated. In this case, the collision protection device 2 determines the distance D″ for the obstacle O located in the monitoring area 22, between the vehicle door 11 and the vehicle 1. If the distance D″ is smaller than or equal to a predetermined threshold value, the collision protection device 2 stops and/or reverses the adjustment movement of the vehicle door 11 along the second adjustment direction D2.

In FIG. 5B, analogously to FIG. 4B, the vehicle door user U is in part between the vehicle door 11 and the vehicle 1, and in part inside the vehicle 1. In this case, the vehicle door user U introduces an adjustment force, acting along the second adjustment direction D2, into the vehicle door 11, via the inside door handle. The vehicle door user U is at least in part in the test area 24. The collision protection device 2 is thus deactivated. The detection of the obstacle O, by the collision protection device 2, in the monitoring area 22 beyond the vehicle door 11 does not lead to stopping and/or reversal of the adjustment movement, on account of the adjustment device D2.

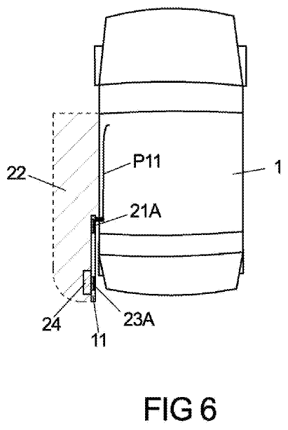

FIG. 6 shows a vehicle 1 comprising a vehicle door 11 which is mounted on the vehicle 1 such that it can be shifted along an adjustment path P11. The vehicle 1 furthermore comprises a further embodiment of the proposed system. The system comprises a monitoring sensor 21A for monitoring the monitoring area 22, and a presence sensor 23A for detecting the presence of at least one part of the vehicle door user U in the test area 24. Analogously to the above statements regarding FIGS. 3A to 5B, the system is configured to deactivate the collision protection device 2 if the testing by means of the presence sensor 23A reveals that at least one part of the vehicle door user U is in the test area 24. The collision protection device 2 is in turn configured to stop and/or to reverse an adjustment movement along the adjustment path P11 if the collision protection device 2 is activated and the monitoring sensor 21A detects an obstacle O in the monitoring area 22. In this case, the detection of the obstacle O can in particular include a determination of a distance D′, D″ between the vehicle door 1 and the obstacle O, and testing as to whether the distance D′, D″ falls below a predetermined threshold value.

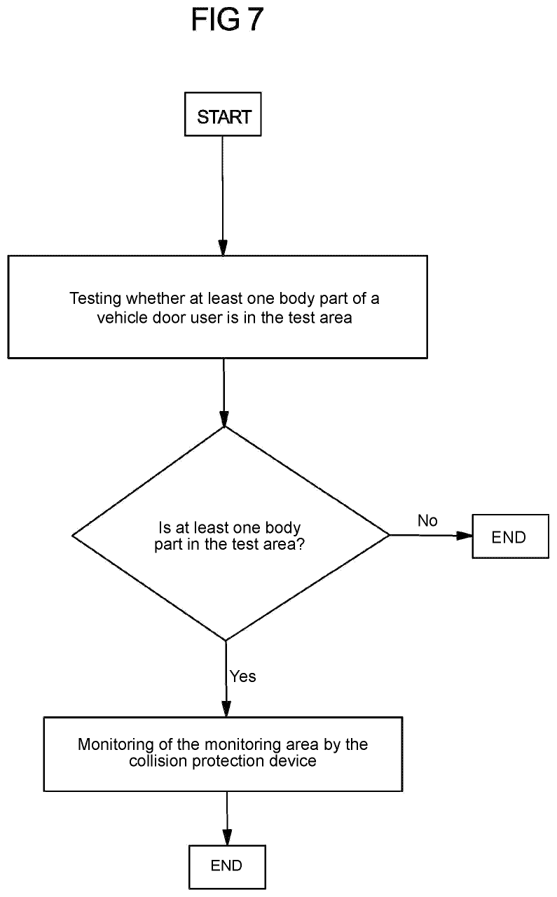

FIG. 7 is a flow diagram of the proposed method. In this case, the method comprises, after the start, at least using the at least one presence sensor 23A to test whether at least one body part of a vehicle door user U is in a test area 24, and controlling the collision protection device 2 on the basis whether a body part of a vehicle door user U is in the test area 24. In this case, the monitoring of the monitoring area 22 by the collision protection device 2, using the at least one monitoring sensor 21A, 21B, takes place on the basis the testing.

In an alternative embodiment, the testing can comprise a detection of whether the vehicle door user U is touching at least one operating element, in particular the outside door handle 111 or the inside door handle, on the vehicle door 11. By way of example, the detection of touching can be carried out by means of at least one touch sensor.

In one embodiment of the proposed method, the collision protection device 2 can be activated in response to the vehicle door user U touching the inside door handle. In contrast, in the event of touching of the outside door handle, the collision protection device 2 may not be activated.

In a further embodiment, the adjustment of the vehicle door 11 can take place, in a servo mode, in a motor-assisted manner.

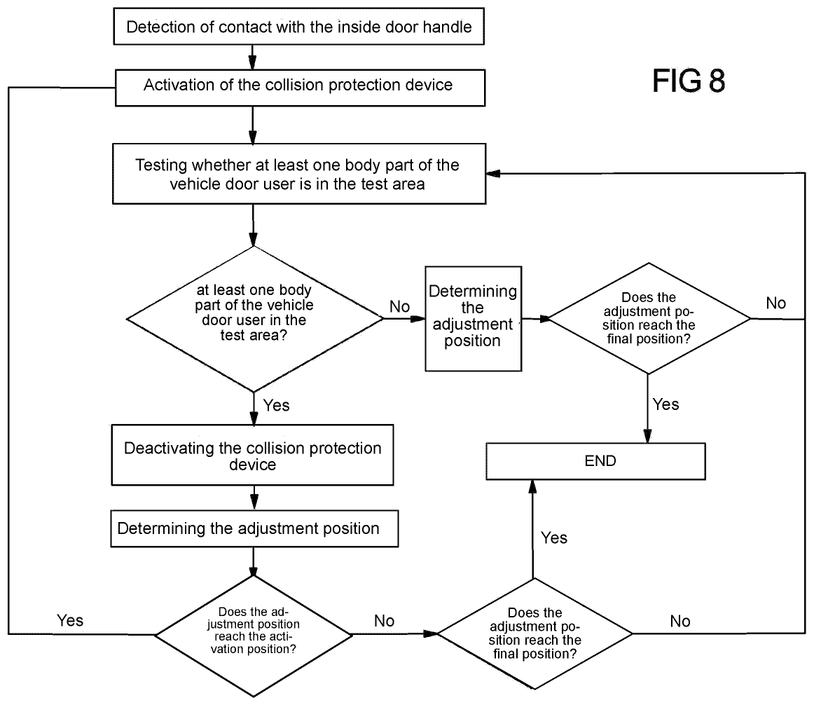

FIG. 8 is a flow diagram of a further embodiment of the proposed method. According thereto, the proposed method is triggered by an operating event of the vehicle door 11, in which touching of the inside door handle is detected.

The collision protection device 2 is activated as a result. The testing as to whether at least one body part of the vehicle door user U is in the test area 24 subsequently takes place. If it is not possible to identify that at least one body part of the vehicle door user U is in the test area 24, a determination of the adjustment position of the vehicle door 11 takes place. Based on the adjustment position, a further test is carried out as to whether the adjustment position has reached a final position. In the event of the final position having been reached, the method is ended. Otherwise, a test is again carried out as to whether at least one body part of the vehicle door user U is in the test area 24. If the test for the presence of at least one body part of the vehicle door user U reveals the at least one body part of the vehicle door user U is in the test area 24, the collision protection device 2 is deactivated. Subsequently, the determination of the adjustment position, and a check of whether the adjustment position has reached the activation position, take place. In response to the activation position being reached, the collision protection device 2 is activated again. If the activation position is not reached, testing takes place as to whether the adjustment position has reached the final position. If the final position is not reached, a test is again carried out as to whether at least one body part of the vehicle door user U is in the test area 24. In contrast, if the adjustment position has reached the final position, the method is ended.

In a further embodiment, the proposed method can include the determination of the expected and/or actual adjustment movement.

In a further alternative embodiment, the test area 24 can be able to be determined on the basis of an expected and/or actual adjustment movement of the vehicle door 22. The adaptation of the test area 24 can take place by means of the plurality of presence sensors 23A, 23B. For the adaptation of the test area 24, presence signals S23 from a selection of the plurality of the presence sensors 23A, 23B can be ignored. In this case, the selection can depend on the expected or the actual adjustment direction D1, D2 of the vehicle door 22.

Furthermore, in the case of an activated collision protection device 2, the testing can be repeated at predetermined time intervals.

Alternatively or in addition, the collision protection device 2 can also be activatable again, following the deactivation, on the basis of the adjustment speed of the vehicle door 11.

In a further alternative embodiment, the proposed method can also include displaying the result of the testing for presence and/or a detection of an obstacle O, via an optical and/or acoustic signal.

### LIST OF REFERENCE SIGNS

1 vehicle
D1 first adjustment direction
D2 second adjustment direction
11 vehicle door
P11 adjustment path
L11 longitudinal extension axis
111 outside door handle
12 adjustment mechanism
α, α1, α2 opening angle
2 collision protection device
D′, D″ distance
21A, 21B monitoring sensor
S21 monitoring signal
22 monitoring area
23A, 23B presence sensor
S23 presence signal
24 test area
3 control unit
S3A deactivation signal
S3B activation signal
4 use sensor
S4 use signal
O obstacle
U vehicle door user

1. A method for adjusting a vehicle door, at least comprising the following steps:
using at least one presence sensor to test whether at least one body part of a vehicle door user is in a test area, and
controlling a collision protection device of the vehicle door on the basis of whether a body part of the vehicle door user is in the test area, wherein the collision protection device is configured to monitor a monitoring area that differs from the test area and is in the area surrounding the vehicle door for possible obstacles using at least one monitoring sensor in order to avoid a collision between the vehicle door to be adjusted and an obstacle.

2. The method according to claim 1, wherein the testing comprises a detection of whether the vehicle door user is touching at least one operating element on the vehicle door.

3. The method-according to claim 2, wherein a test is performed as to whether the vehicle door user is touching an outside door handle or an inside door handle of the vehicle door.

4. The method according to claim 3, wherein the collision protection device is activated if the testing reveals that the vehicle door user is touching the inside door handle.

5. The method according to claim 1, wherein the collision protection device is coupled to an adjustment mechanism of the vehicle door that comprises at least one motorized drive, which is provided for assisting an adjustment of the vehicle door that is actuated by muscle power.

6. The method according to claim 1, wherein the testing is triggered by an operating event brought about by the vehicle door user.

7. The method according to claim 2, wherein the testing is triggered by an operating event brought about by the vehicle door user, wherein the operating event is brought about by touching the at least one operating element.

8. The method according to claim 1, wherein the test area is determined on the basis of an expected or actual adjustment movement of the vehicle door.

9. (canceled)

10. The method according to claim 1, wherein the collision protection device is activated, and is deactivated if it is identified, by means of the at least one presence sensor, that a body part of the vehicle door user is in the test area, or the collision protection device is deactivated, and is activated if it is identified, by means of the at least one presence sensor, that there is no body part of the vehicle door user in the test area.

11. The method according to claim 1, wherein at least one of
the testing is repeated at predetermined time intervals and
the testing is repeated at predetermined time intervals, in response to an adjustment of the vehicle door into a predetermined test position.

12. (canceled)

13. (canceled)

14. The method according to claim 1, wherein the collision protection device is activated if an adjustment position of the vehicle door reaches a predetermined activation position.

15. (canceled)

16. The method according to claim 1, wherein the collision protection device is activated on the basis an adjustment speed of the vehicle door.

17. The method according to claim 1, wherein the collision protection device is activated if it is identified, by sensors, that the vehicle door is adjusted by a vehicle door user at an adjustment speed that exceeds a predefined speed threshold value.

18. The method according to claim 1, wherein a result of the testing and/or a detection of an obstacle is displayed via an optical and/or acoustic signal.

19. The method according to claim 1, wherein the at least one monitoring sensor is a radar sensor.

20. A system for adjusting a vehicle door, comprising:
a collision protection device comprising at least one monitoring sensor, wherein the collision protection device is configured to monitor a monitoring area in the area surrounding the vehicle door for possible obstacles using at least one monitoring sensor in order to avoid a collision between the vehicle door to be adjusted and an obstacle,
at least one presence sensor, and
a control unit which is coupled to the at least one presence sensor and the collision protection device and which is configured to test, by means of the at least one presence sensor, whether at least one body part of a vehicle door user is in a test area that is different from the monitoring area, and to control the collision protection device on the basis of whether a least one body part of the vehicle door user is in the test area.

21. The system according to claim 20, wherein at least one of
for motor-assisted pivoting of the vehicle door, the system comprises at least one drive that is coupled to an adjustment mechanism of the vehicle door,
the system comprises at least one touch sensor, coupled to the control unit, for touch detection on at least one operating element of the vehicle door,
the system comprises, for identifying an operating event of the vehicle door, at least one use sensor that is coupled to the control unit, and the control unit is configured to trigger the testing in response to the operating event, and
the system comprises, for identifying an adjustment position of the vehicle door, at least one position sensor that is coupled to the control means, and the control unit is configured to trigger a repeated testing if the adjustment position reaches a predetermined activation position.

22. (canceled)

23. (canceled)

24. (canceled)

25. The system according to claim 20, wherein the control unit is coupled to a timer and is configured to repeatedly test at predetermined time intervals.

26. The system according to claim 25, wherein the control unit is configured to deactivate the activated collision protection device if repeated testing reveals that at least one body part of the vehicle door user is in the test area.

27. A vehicle comprising an adjustable vehicle door and a system according to claim 20.
